(19) United States
(12) Patent Application Publication
(10) Pub. No.: US 2008/0114612 A1
(43) Pub. Date: May 15, 2008

(54) RESPONDER ROUTE AND SITE-SPECIFIC CRITICAL DATA SYSTEM

(76) Inventors: Frank A. Needham, Sequim, WA (US); Robert L. Anundson, Sequim, WA (US); Gary R. Smith, Port Angeles, WA (US); Karen F. Goschen, Sequim, WA (US)

Correspondence Address: VIRGINIA P. SHOGREN, P.C., 435 W. BELL STREET, SUITE A, SEQUIM, WA, 98382, US

(21) Appl. No.: 11/936,225

(22) Filed: Nov. 7, 2007

Related U.S. Application Data
(60) Provisional application No. 60/858,910, filed on Nov. 13, 2006.

(51) Int. Cl. G06Q 50/00; G01C 21/00; G01S 5/00; G06F 3/14

(52) U.S. Cl. 705/1; 342/357.06; 342/357.07; 701/207

(57) ABSTRACT

A route and site-specific critical data system for emergency responders as they travel and approach an incident site, comprising a field survey database, a computer-executable GIS extension application interfaced with said database, a mobile GPS receiver, and a mobile user interface that includes a display screen capable of touch-screen icon selection including through gloved hands. The user interface mounted within one or more response vehicles displays multiple screen images, map-based, and photograph-based information, detailed text narratives and data in real-time along the entire route to an incident site, including past the public/private road intersection.

### CROSS REFERENCE TO RELATED APPLICATION

This is the Regular U.S. Patent Application of prior Provisional Patent Application Ser. No. 60/858,910 filed Nov. 13, 2006 by the same inventors, entitled “Emergency Response Route Data System”, the priority of which is hereby claimed under 35 USC 119(e), 120, and the disclosure of which is hereby incorporated by reference in its entirety.

### FIELD OF THE INVENTION

This invention relates generally to the field of emergency response and in particular to an integrated GIS and GPS-based system to meet the unique challenges of first responders in rural areas by providing those responders with critical route and site specific information, including site-specific information past the public/private intersection.

### BACKGROUND OF THE INVENTION

Rural Fire and Emergency Medical Service (“EMS”) Districts face unique challenges based on their large area and the lack of funds and specialized equipment compared to urban fire districts. Rural fire districts respond to emergency events in remote areas, and the emergency vehicles often travel over lengthy private roads and/or private driveways. Rural fire districts also suffer from lack of sufficient information for “pre-fire” plans, a term used to describe information about a road, structure or home site, which the districts maintain in advance of an emergency event.

Response team commanders need as much pre-fire information as possible. The commanders, such as a Fire Chief, are responsible for making critical decisions as quickly as possible about how to address the emergency “on the fly” as the responders are traveling to the emergency site. These critical decisions include: 1) deployment decisions; 2) equipment position decisions to maximize functionality onsite; 3) crew position decisions for containment and rescue efforts; 4) water access decisions, i.e., whether and how an engine can access available water sources; and, 5) how to address/contain hazards at the site or in the course of reaching the site that would hinder rescue efforts.

To help commanders make these decisions, rural EMS Districts typically collect data about their district by making training runs to various properties and recording by hand what they observe. This gives the responders the opportunity to accomplish a training purpose, while familiarizing crews with potential fire address locations and onsite conditions. The districts incur the costs of moving personnel and equipment to the various sites and back to the district station. However, in the course of the training runs, the fire and EMS Districts typically do not attempt to record the terrain, road surfaces, vegetative fuels, or other risk enhancers. Nor is information recorded or readily available for how to deploy equipment once the responder reaches a particular site. Districts traditionally have not been able to afford to adequately collect or maintain this information due to time constraints and limited crew availability.

As a result, the commanders are often left making critical decisions based on: 1) pre-fire plans that are maintained on index cards that contain limited information; 2) pre-fire plans maintained on hand-written sheets in binders that make sharing information with more than one person difficult; 3) pre-fire plans that contain little to no information regarding the physical characteristics of private roads, long rural driveways, or rural property structure(s); 4) limited site-specific information not including GPS coordinates; 5) no readily available information on the physical conditions of the site that could restrict the fire fighters' ability to suppress fire or save lives; 5) outdated information; 6) unknown route and site hazards and exposures placing crew safety and equipment protection at risk with no known information available to mitigate the risk; 8) no available/readily accessible information regarding off-site water sources; 9) no information about private roads that may not meet the same engineering and design standards as public roads making it difficult to know which engines can maneuver over a particular private road or driveway; and, 10) long distances to travel making estimates of time to reach the emergency site difficult to make. The National Fire Protection Association (NFPA) contends that for every 15 seconds saved, the protection of crew and inhabitants is improved by 25%, and the property damage is reduced by more than $20,000.

More recently, rural Fire and EMS Districts have begun moving towards use of Global Positioning Satellite (“GPS”) technology to assist in navigating emergency vehicles to incident sites. However, while the GPS receivers are useful, the technology only gets the crews to the intersection where public and major private roads intersect with driveways. In addition, the GPS data is still primarily in list form and is not generally integrated with map or digital images. Consequently, the typical GPS system does not lend a visual aid to the responder and does not provide the districts with critical information past the public and private road/driveway intersection.

Accordingly, there is a need in the art for a system that provides comprehensive, accurate, and real-time data critical to emergency responders along the route and past the public/private road intersection to allow commanders to make critical decisions in advance of reaching the emergency site. Such data would allow responders to, among other things: 1) make deployment decisions while moving towards the incident site; 2) pre-position equipment to maximize its functionality onsite; 3) move crews faster and more efficiently into containment and rescue efforts; 4) provide advance data about the actual incident site and available nearby water resources; and, 5) provide advance knowledge and awareness of additional hazards both at the site and in the course of reaching the site.

### THE INVENTION

### SUMMARY OF THE INVENTION

The inventive Responder Route and Site-Specific Critical Data System is a computer-enabled critical decision assist system and method for collecting, maintaining, and providing information to at least one emergency responder relating to an emergency travel route and an emergency incident site. The system comprises in operative combination a field data collection system for collecting field survey route and site data; three databases that include the field survey route and site data; and a user interface system. The user interface system comprises at least one computer, at least one computer-user interface, at least one computer screen display, at least one district database accessible by said computer, and a critical data display application program capable of automatically generating and displaying at least one critical data display whereby information is provided to one or more responders to assist in making at least one critical decision in advance of reaching the incident site.

The critical data display program comprises the functionality of entry of incident data, access code verification, access to route and site-specific data corresponding to the incident data, access to data supplied by at least one receiver, and automatic generation and display of at least one critical data display. Access to the data is secured against inappropriate internal use or access by third parties via double encrypted keys.

After entering an emergency vehicle, powering up/activating the computer, and entering incident data and an access code via the computer-user interface, the responder is provided a display of multiple screen images containing critical route and site-specific data, including map-based information, photographs, detailed thumbnail narratives, and real-time information received through a GPS receiver or other sensors. The customizable user interface is mounted within emergency response vehicles and is responsive to touch by fingers, including gloved fingers, and/or voice commands as the vehicle is driven to the incident site.

The data displayed comprises critical information past the private/public intersection, such as location and type of gates, fences, lights, or security measures, private roadway construction and surfaces, road width, fences, culverts and ditches, aboveground utilities, gas tanks, vegetation type and canopy height; water sources, including rivers, lakes, ponds, hydrants, bridges and culverts; home site data including type of structures (such as wood, masonry, metal), number of floors, roof construction (such as composite, shake, tile), garage existence, type and location; existence and location of any accessory buildings; ingress points, parking areas, vehicles, pets, other animals, and home owner and resident information. The system also includes a clock program for tracking the amount of time required to reach the incident site and a clock program linked to a GPS receiver for calculating and recording the vehicle's location at set time intervals after leaving the station.

The system provides emergency responders with critical information as they are in the process of reaching the incident site, thereby allowing for time to assess conditions and make advance decisions regarding: 1) equipment deployment; 2) equipment position; 3) crew assignments; 4) the impact of site characteristics on containment plans; 5) nearby water resources; 6) potential hazards at the site and in the course of reaching the site past the public/private intersection; 7) overall fire suppression and occupant safety and rescue plans. Route and site-specific information supports improved first response arrival times, pre-planned equipment deployment, and more effective suppression methods thereby helping to protect lives and preserve property.

### BRIEF DESCRIPTION OF THE DRAWINGS

The invention is described in more detail with reference to the attached figures, in which:

FIG. 1 is a diagram of components of the Responder Route and Site-Specific Critical Data System of the present invention;

FIG. 2A is a block diagram of the hardware, software and data components of the Responder Route and Site-Specific Critical Data System;

FIG. 2B is a block diagram of the hardware, software and method of updating the data for the Responder Route and Site-Specific Critical Data System;

FIG. 3 is a diagram illustrating a route and site for an exemplary field survey;

FIGS. 4A-4D are thumbnail views of exemplary screen displays for the user interface in operation;

FIG. 5 is an exemplary user interface screen shot/critical data display with multiple windows;

FIG. 6 is an alternate embodiment of an exemplary user interface screen shot/critical data display with multiple windows; and,

FIG. 7 is a flow chart of an exemplary operation of the Responder Route and Site-Specific Critical Data System by an emergency response team.

### DETAILED DESCRIPTION OF THE PREFERRED EMBODIMENT

The following detailed description illustrates the invention by way of example, not by way of limitation of the scope, equivalents or principles of the invention. The invention is illustrated in the several figures, and is of sufficient complexity that the many parts, interrelationships, and sub-combinations thereof cannot be fully illustrated in a single patent-type drawing. For clarity and conciseness, several of the drawings show in schematic, or omit, parts that are not essential in that drawing to a description of a particular feature, aspect or principle of the invention being disclosed. Thus, the best mode embodiment of one feature may be shown in one drawing, and the best mode of another feature will be called out in another drawing.

Responder Route and Site-Specific Critical Data System

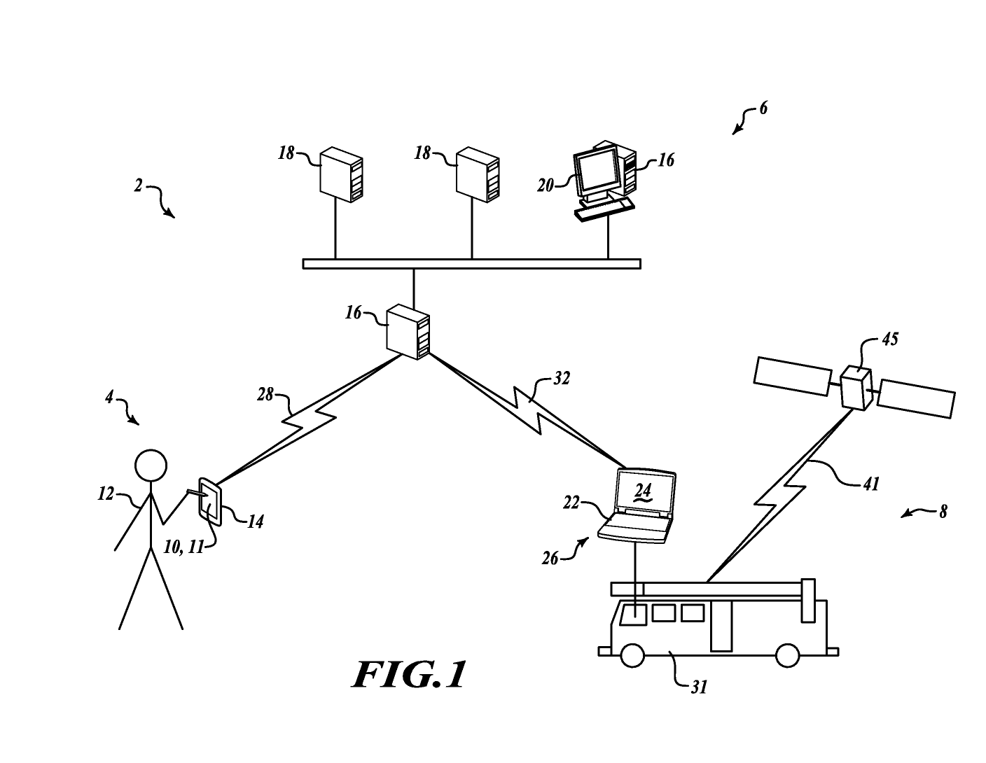

FIG. 1 shows an overview of the primary sub-components of the Responder Route and Site-Specific Critical Data System 2: a Field Data Collection System 4, a Database Maintenance System 6, and a User Interface System 8.

Field Data Collection System

Referring to FIG. 1, the Field Data Collection System 4 comprises a method for collecting field survey route data 10 and field survey site data 11 by field technicians 12 through manual and/or electronic means 14.

Field Technician

Referring to FIG. 1, the field technician 12 is shown inputting data 10, 11 on a mobile handheld Personal Digital Assistant (“PDA”) 14. Any suitable device or combination of devices may be used by the field technician 12 to collect the data 10,11, including, without limitation, manual recordings, a cell phone, a PDA, a tablet computer, a global positioning system receiver, a clock, a camera, a video recorder, a voice recorder, and a laptop computer. The field technician 12 may utilize any desirable GPS tools, digital cameras, video equipment, and specialized data collection equipment and software to collect information along routes and at potential incident sites.

In the preferred embodiment, the field data 10, 11 is collected as at least one field technician 12 travels a route to a potential incident site in a vehicle. The field technician 12 operates equipment that is either hand-held and/or mounted to the vehicle while traveling the potential emergency route. At the commencement of the route, the field technician 12 activates the equipment. Along the course of the route, the field technician 12 records data orally, through periodic activation of the equipment, and/or automatically by sensors or other automated electronic means.

As an example, computers, digital cameras, video recorders or audio recorders may be hard-mounted to the interior and exterior of a vehicle, as desired, for data collection. Upon commencement of the route, the field technician 12 initiate's devices, including devices enabling GPS technology, to either manually or automatically record information and data at the inception of the route and at certain intervals along the route based on distance, location and/or time. Simultaneously, the field technician 12 orally describes physical attributes of the route, said comments recorded and/or converted to written words through voice recognition software as the field technician travels the route. The field technician 12 may further remotely operate a digital camera mounted to the vehicle to take photographs at intervals and at the potential incident site.

Field Survey Data

The data collected by the field technician 12 is primarily two-fold: route data 10 regarding the vehicle route between the responder station and the incident site, and site data comprising incident site-specific data. The field survey data 10, 11 extends past the private/public intersection and is site-specific. Route data 10 comprises private road conditions, driveway information and vegetation coverage; site data 11 comprises structure information, occupant information, personal effects/possessions information, staging area information, water information, vegetation coverage, deployment area information, hazards, utility locations and types, and parking facilities information.

Each data type is coded for entry and retrieval purposes. Table A contains an exemplary list of data subjects illustrating the comprehensiveness and detail of field survey route and site data collected in the field survey:

TABLE A

| Route Critical Data | Site Critical Data | Site Critical Data |
|---|---|---|
| Private Road Name or Number | Physical Address/Postal Address | Geocode and Fire Address |
| Private Road Surface - asphalt, | Structure types, square footage, | Staging area width and distance |
| concrete, gravel, dirt, other | volume, materials | from site |
| Private Road Visibility | Garage size, living quarters, | Staging area length |
| | hazardous materials, vehicles | |
| | within, storage facility | |
| Private Road Slopes - up/down, | Outbuildings | Hydrant By Type |
| percentage grades | | |
| Private Road Features - culvert | Onsite and Offsite Water By | Onsite Water Distance From |
| size, bridge type, weight | Type | Structure |
| restrictions, weather restrictions | | |
| Private Road Conditions - , | Onsite Water Source | Onsite Water Location by |
| shape/width, straight, curved, | | Quadrant |
| rolling, steep, two-lane, single | | |
| lane, potholes, washboard | | |
| erosion | | |
| Private Road Speeds | Decks, porches, patios type, | Offsite Water Location |
| | materials, size | |
| Private Road and Driveway | Roof materials | Pump house location and |
| Intersection Condition | | distance |
| Intersection Angles | Roof slope | Well head location and distance |
| Driveway Surface | Occupants Information - number, | Obstacles - trenches, holes, |
| | gender, age group, health | swimming pool, hot-tub, heat |
| | | pump, fences, gazebos, |
| | | fireplaces |
| Driveway Features | Structure Interiors | Deployment distance from |
| | | structure |
| Driveway Slope | Tanks - location and distance | Restrictions |
| | form structure | |
| Driveway Shape | Gas Lines | Deployment area location |
| Driveway Width/Length | Septic tank location and distance | Deployment Area Width |
| Cattle guard | Ditches | Ingress and Egress Points |
| RR Tracks | Equipment, recreational vehicles, | Drain field location distance and |
| | boats, farm equipment | size |
| Bridges | Fences | Electric Utilities |
| Gates | Structure Vegetation | Telephone |
| Road Vegetation Coverage | Vegetation Fuel Load Factor and | Cable |
| | Ratings | |
| Driveway Vegetation | Vegetation Distance from | Outbuilding Construction |
| | Structure | materials |
| Culverts | Deployment area length | Outbuilding distance from |
| | | structure |
| Transformer Utilities | Pets and Personal Effects | |

In the preferred embodiment, the field technician(s) enter textual information on a laptop computer using a program that prompts the fields of information in Table A and includes lists of materials or attributes to choose from. The data entry is subject to at least two quality control measures. First, as the data is entered, if a field is skipped, the field technician is notified via a pop-up box. Second, when the field survey is completed, the technician is notified of any missing entries and is given the opportunity to add the missing data.

In addition to the data collected by the field technicians, property owners are given the opportunity to voluntarily provide information regarding their property and may electronically update that information as it changes via the Internet.

Database Maintenance System

Referring to FIG. 1, the field survey data 10, 11 is uploaded 28 to at least one database 16 in the Database Maintenance System 6. The data 10, 11 may be replicated on one or more additional databases 18 at the same or remote locations. The Database Maintenance System 6 further comprises at least one computer 20. The databases 16, 18 include maps, graphics, photographic images, videos, animations, audio information, narrative information, and combinations thereof. Access to data on all databases is highly restricted via encryption keys for security purposes.

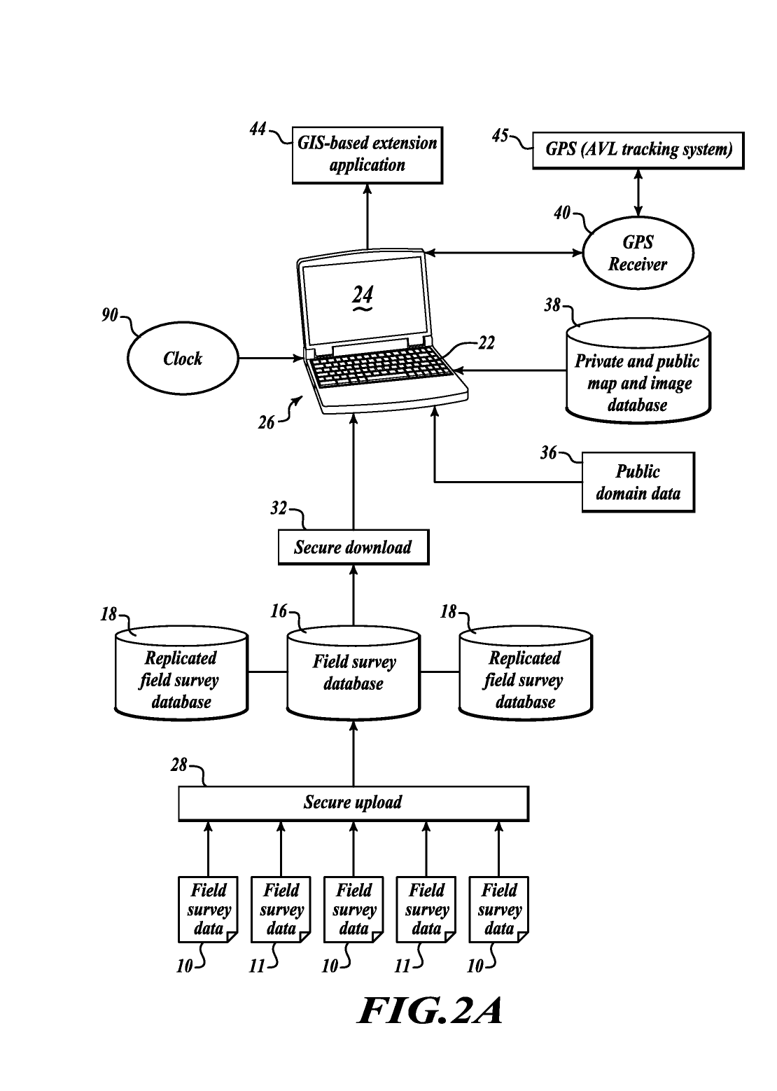

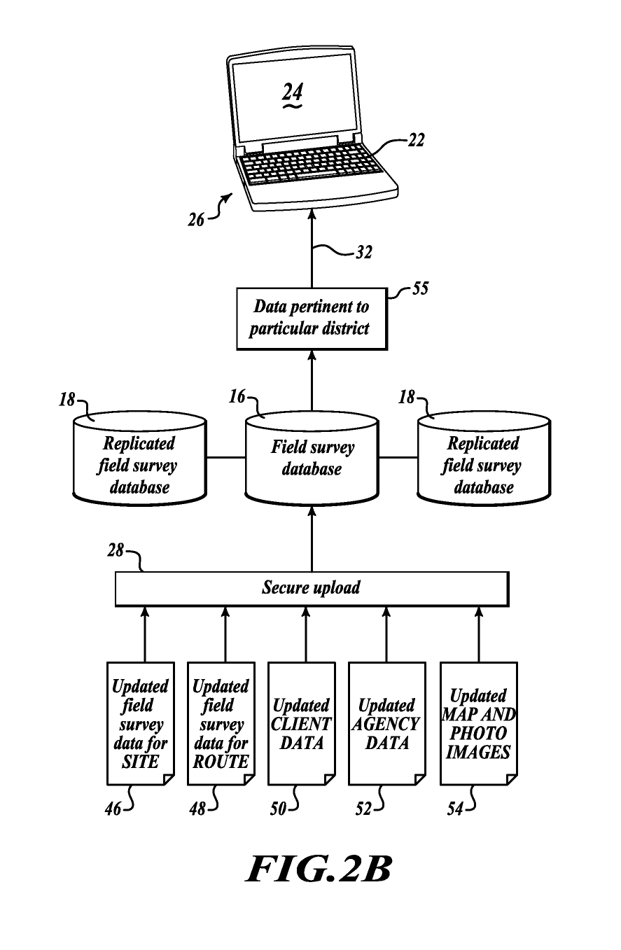

As discussed on connection with FIG. 2(b), the database 16 is updated periodically based on new or updated information from field technicians 12 and other sources.

User Interface System

Referring to FIG. 1, the User Interface System 8 comprises at least one vehicle 31 carrying at least one laptop computer 26 with a computer-user interface 22, such as a keyboard, and display screen 24. The vehicle 31 shown in FIG. 1 is a fire engine; however, any suitable emergency or other type of vehicle 31 may be utilized, and the vehicle 31 may be controlled by the driver, or remotely in the case of a robotic embodiment. As further discussed in connection with FIG. 2(a), the laptop computer 26 further comprises computer-readable memory onto which the field data 10, 11 with any updates is downloaded 32 along with a GIS-based critical data display program 44. The preferred embodiment of the critical data display program 44 utilizes software such as Visual Studio, Map Point or the like, on an ESRI, Manifold, HTML or similar platform with NAVTEQ or similar map data. Any suitable software and databases or combination thereof may be utilized. The laptop computer 26 is further programmed to receive GPS data 41 from a receiver and GPS system 45.

In the preferred embodiment, the laptop computer 26 is powered via an articulating and/or swivel-mounted docking station mounted to the dashboard or a pedestal within the emergency response vehicle 31. One or more responders and/or the commander may view the display screen 24 as the crew travels towards the incident site. Multiple vehicles 31 may have access to the same critical data via multiple computers and may communicate with each other via voice or text-based electronic communications. The computer in the user interface system may be any one of the following: a PDA, a tablet computer, a laptop computer, notebook computer, and/or a cell phone, including smart phones.

FIG. 2A shows a block diagram of the database and application components of the present invention. Referring to FIG. 2A, field survey data 10, 11 resulting from a plurality of field surveys is securely uploaded 28 to the field survey database 16. Replicated databases 18 are maintained for security purposes. All databases are access-protected via encryption or other methods.

Referring to FIG. 2A, data from the field survey database 16 is shown being securely downloaded 32 to a laptop 26 comprising a user input device/keyboard 22 and a screen display 24. Access to the data on the laptop 24 is protected via encrypted keys or other methods. Private and public map and image data 38 maintained on a separate database 38 is also downloaded to the laptop computer 26. Additional information that is publicly available 36, such as site owner contact information, physical addresses, fire addresses, and the like, are also downloaded to the laptop computer 26.

In the preferred embodiment, the field survey data 10, 11, the private and public map and image data 38 and public domain data 36 downloaded to the laptop computer 26 are limited in scope to the area of the particular fire district or EMS district using the system 2 and are encrypted for high level security. Alternatively, the data may include several neighboring districts or portions of districts, as desired by the responder fire district or EMS district. Access to data from other districts requires separate access codes to bypass additional encryption keys.

Referring to FIG. 2A, the laptop computer 26 is further programmed to receive and display real-time information via wireless receivers and wireless browsers interfaced with the system. The real-time information may be received from GPS systems 45, satellite systems, remote sensors, the internet, communications with dispatchers, and/or communications from other emergency vehicles and persons working with the responders. For example, the system maintains communications with an Advanced Vehicle Location GPS system 45 through a receiver 40 located on the responder vehicle. A user of the system may also access real-time information over the internet via a wireless browser. For example, weather information is available in real-time through an internet-based software application downloaded to the laptop computer 26 with browser/wifi connection to the internet.

The laptop computer 26 is also programmed to record the time required to reach the incident site through means of a clock 90 either manually activated by the responders at the commencement of the route or activated through electronic/automated means. The clock 90, in association with the GPS receiver 40, may be further activated at set intervals (e.g., every 5, 8, and 15 minutes) to record the location of the emergency response vehicle along the route to the incident site at specified time intervals. In the preferred embodiment, the clock 90 is programmed to calculate: 1) the time required for the responder to reach the public/private intersection, as determined by a match between real-time GPS coordinates received via the GPS receiver 40 and GPS coordinates previously recorded as part of the field survey route data 10; 2) calculate the time to reach the incident site from the public/private intersection; and, 3) conduct a back-haul check on the time required for the vehicle to return back to the station.

Referring to FIG. 2A, the computer-user interface 22 for the laptop computer 26 may be any one or a combination of a keyboard, touchpad, touch-screen icons, a screen display responsive to a stylus, a computer mouse, voice recognition software responsive to voice/oral commands, and/or an optical display screen capable of optical screen pointer control. In the preferred embodiment, the computer-user interface 22 comprises a combination of a keyboard and touch-screen icons capable of manipulation by the gloved hands of responders.

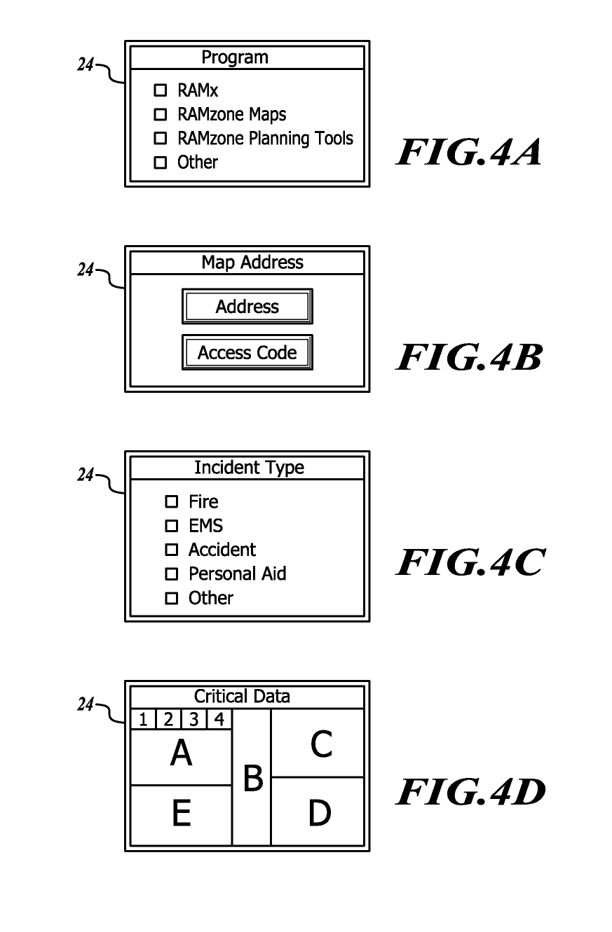

As further discussed in connection with FIGS. 4-6, a GIS-based critical data display program 44 downloaded to the laptop computer 26 enables the display of critical data on the screen display 24, including without limitation, field survey data 10, 11, private and public map and image data 38, public domain data 36, weather data, and GPS location and map data. The critical data display application 44 is programmed to receive incident data such as a site address for an emergency incident. The incident data includes GPS coordinates, Geocode references from a national database, a unique fire address assigned by the fire district, and/or a physical mailing address as used by the post office. The responder also enters an authorized access code which in the preferred embodiment is uniquely assigned to each fire district and periodically changed. The critical data display application 44 is programmed upon entry of the proper access code to verify the code and if correct, bypass one or more encryption keys and provide access to data associated with that site address. The program 44 further has access to data supplied by at least one receiver, and based thereon, is capable of automatically generating and displaying at least one critical data display.

Multiple users of the system 2, such as in the case of multiple vehicles responding to an emergency event, have access to the same data and may further communicate and coordinate efforts via cell phone and/or Internet-based voice and text communications.

FIG. 2B shows a block diagram of the hardware, software and data components involved in periodically updating the field survey database 16 over time to record changed physical conditions and other updated data. Referring to FIG. 2B, the field survey database 16 is updated and/or audited and validated with periodic and/or real-time uploads of various data types, including new or updated field survey data regarding the potential incident site 46, new or updated field survey data regarding the route to the potential incident site 48, new or updated data regarding the district(s) using the system 50, new or updated data from agencies 52, and/or new or updated map and photo images 54. Once uploaded 28 to the field survey database 16, updated data is selected for a particular district 55. Only those updates pertinent to a particular district 55 are downloaded 32 to those particular responders' laptop computers 26 or other user interface devices. Similar security measures, including utilization of encryption keys, are taken with respect to updates. Multiple districts share information via access codes, encryption key release, and/or password exchanges.

The source for the updated data may be the Fire and EMS Districts, field technicians, publicly available databases, and/or information and data collected by the emergency responders as they travel to an incident site and contain an emergency. For example, some Fire and EMS Districts use video cameras attached to the exterior of the emergency response vehicles to record the work done by the emergency responders. This visual recording, along with measurements of time and distance as the responder vehicle travels to the incident site, may be used to validate or update the existing data in the field database 16, and may further be used to measure and track performance (such as response times) against standards based on historical data.

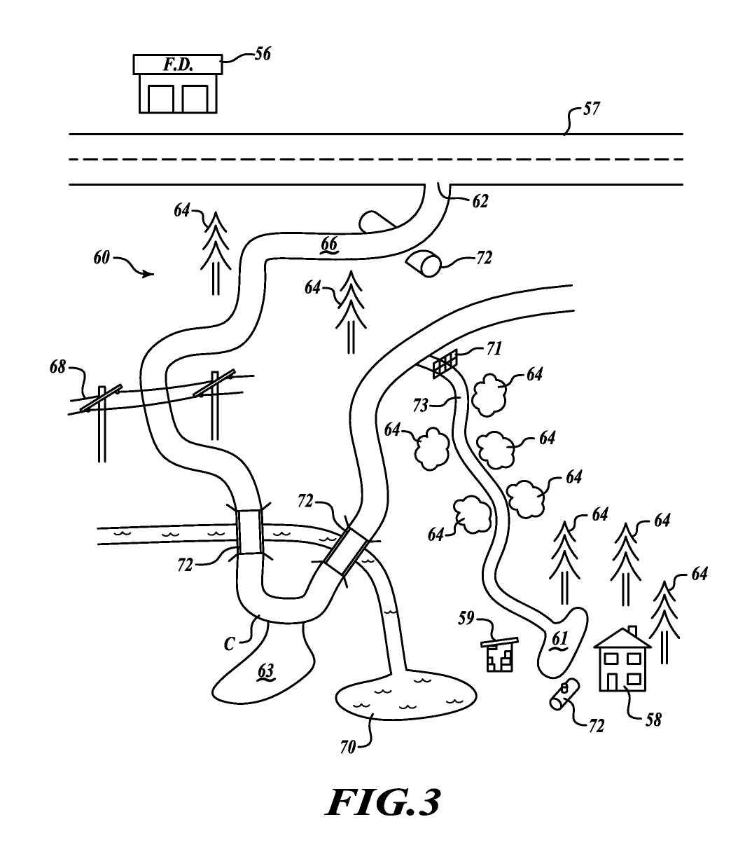

FIG. 3 is a diagram illustrating an exemplary route 60 for the collection of field data 10, 11 as part of the Field Data Collection System 4. As shown in FIG. 3, in collecting the field data 10, 11, the field technician (not shown) travels the route 60 from the responder station 56 to the potential incident site 58. Along the route 60, the field technician gathers various forms of data, such as: GPS data at intervals, including along the highway 57 and at the public/private driveway intersection 62; data relating to vegetation type and canopy 64; data relating to the private road type, width and condition 66; data relating to location, height and type of utilities 68; data relating to the location and nature of any water sources 70 as well as terrain data for the route and at the site; data relating to the location and nature of any hazards or conditions that might pose an obstacle to equipment deployment, such as bridges 72, under-road culverts 72 or gates 71; data relating to accessibility to the site 58 such as hair-pin curves shown by the letter “C” on FIG. 3; data relating to the deployment area 61 and staging area 63; and data relating to the structures at the potential incident site 58, such as home construction type, outbuildings 59, pets, animals, vehicles, vegetation 64, propane tanks or other hazards 72. The field technician also takes photographs at intervals and significant points along the route 60 including at the public-private intersection 62 and the intersection of the private road 66 and driveway 73. Alternatively, the vehicle may be equipped with a digital camera linked to a GPS receiver and programmed for automated photographs to be taken at various locations along the route 60.

Once one route 60 is completed, data may be replicated for other routes up to the point where those additional routes differ from the original route 60. The additional route information may then be added to the field survey data 10, 11.

FIGS. 4A-4D show thumbnail views of exemplary screen displays 24 on the laptop computer or other user interface while in operation. FIG. 4A is a screen display 24 automatically generated upon powering up the laptop computer 26 or other user-interface device. The user is given a choice of programs to activate. The programs include the critical data display application 44 designated “RAMx”, a mapping program designated “RAMzone Maps”, a management program designated “RAMzone Planning Tools,” and “Other” programs, which may include a basic GPS navigation program. In operation, a user touches one of the box icons next to the desired program to bring up the next screen display.

FIG. 4B shows an exemplary screen display 24 automatically generated upon selection of the critical data application program 44 designated “RAMx.” The screen display 24 includes two boxes, one in which a user may type in an address for the incident site; the second box for typing in an access code for verification. In an alternate embodiment, the address is wirelessly transmitted from the dispatch system or station, and the computer is programmed for automatic retrieval and entry of the information.

Assuming a user types in an address and the correct access code, the screen display 24 of FIG. 4C is automatically generated with choices of different incident types, including fire, EMS, accident, personal aid or other. The user touches the box icon next to the appropriate incident type, and the screen display of FIG. 4D is automatically generated and displayed. FIG. 4D shows quadrants of different information that are automatically displayed. Quadrant A contains map information with a choice of different map types including a route map, a topographical map, an ortho photographic map, and a site map. Quadrant B contains functional icons relating to the route and incident site. Quadrants C and D display information and photographs or video based on the selections from Quadrant B. Quadrant E contains icons for information for the response commander to assist in making critical management decisions, a command log, and an icon for a clock program.

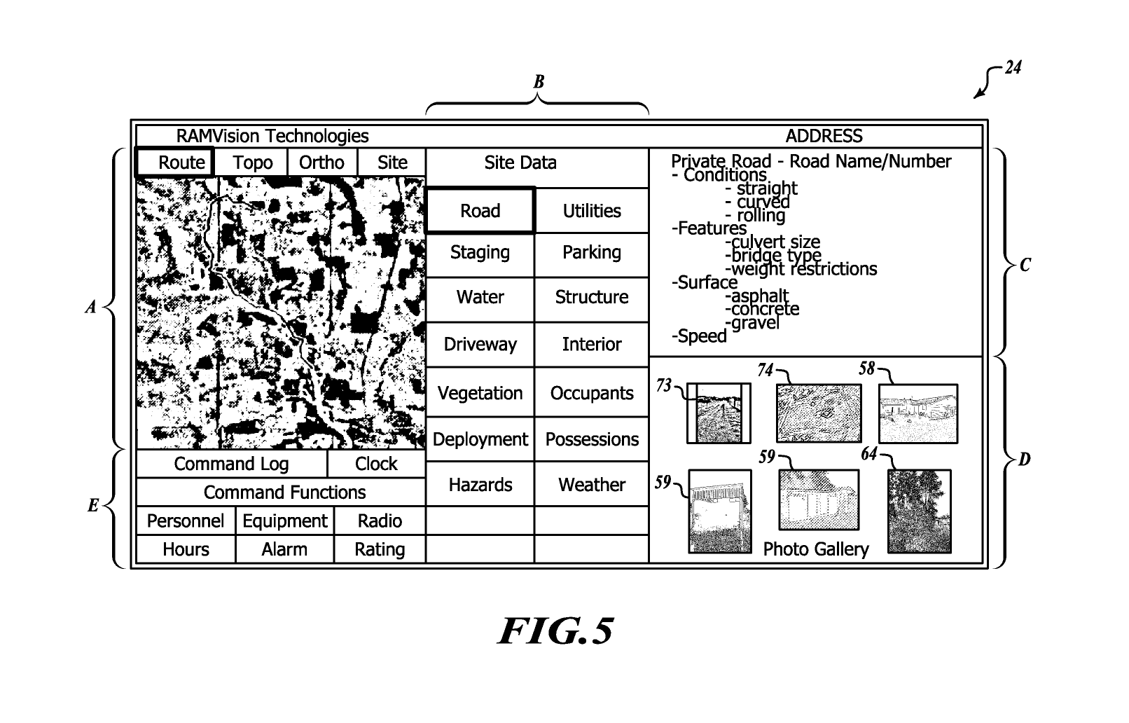

FIG. 5 is an exemplary user interface screen display 24/critical data display 24 with multiple windows showing exemplary icons and exemplary photographs that appear in the quadrants identified in FIG. 4D. Quadrant A of FIG. 5 displays a route map selected from the four map icons labeled “route,” “topo,” “ortho” and “site.” The user of the system 2 may choose to view a route map, a topographical map, an ortho image map, or other types of maps, such as a map limited to the incident site. The screen display 24 may also include plus and minus icons for zooming in or out of the maps for more or less detail.

Quadrant B of FIG. 5 displays icons for site data, including road, utilities, staging, parking, water, structure, driveway, interior, vegetation, occupants, deployment, possessions, hazards and weather. The critical data application 44 is programmed to automatically display in Quadrants C and D information as selected from the touch-screen icons in Quadrant B. As shown in FIG. 5, the “road” icon in Quadrant B has been selected and is highlighted; the corresponding road information is displayed in descriptive text format in Quadrant C. The actual information that is displayed includes private road conditions, features, surface, speed limits and elevation gain.

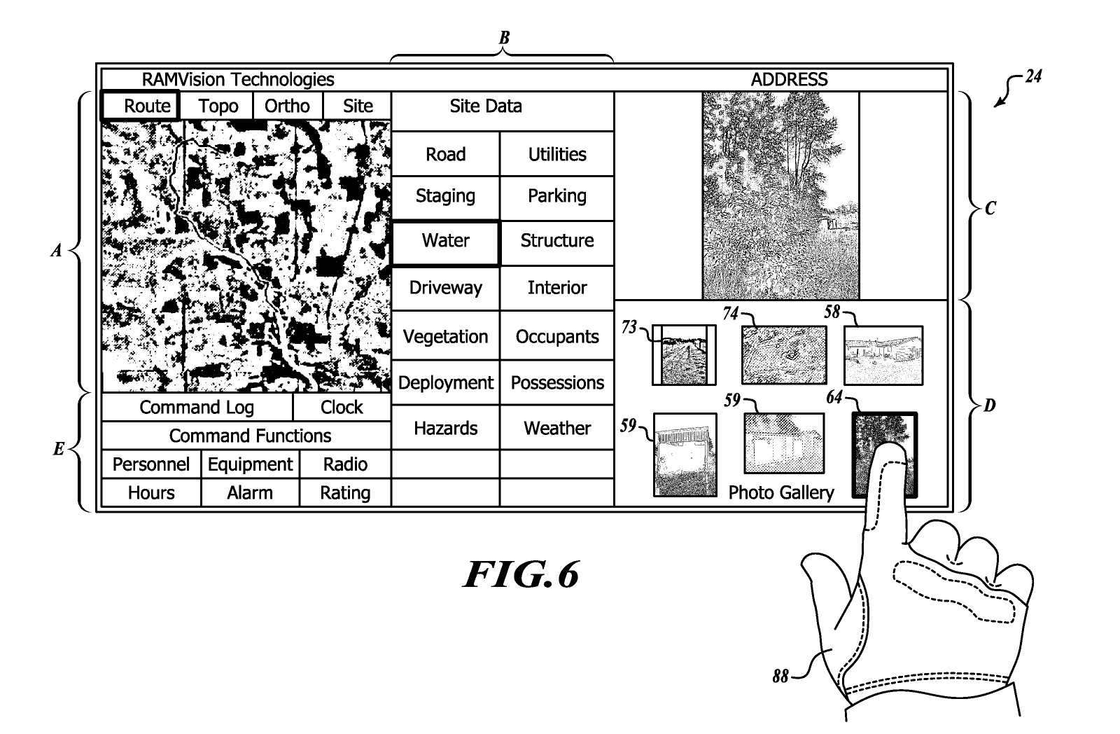

Referring to Quadrant D of FIG. 5, thumbnail photographs of the site are displayed in a photo gallery. The photographs include thumbnail images of the home 58, outbuildings 59, driveway 73, vegetation 64, and an aerial view of the site 74. Touch-screen activation of any of the photographs in the photo gallery of Quadrant D causes that photograph to be enlarged and displayed in Quadrant C as shown in FIG. 6. The enlarged photo may overlap into Quadrants C and D.

Quadrant E of FIG. 5 contains icons related to incident management by a commander or other person in authority. The icons are labeled and include a “Command Log”, a “Clock,” and command functions including “Personnel,” “Equipment,” “Radio,” “Hours,” “Alarm” and “Rating.” By touching any of these icons, the application 44 is programmed to display information related to that icon label in Quadrant C of the screen display 24.

Referring to Quadrant E of FIG. 5, if a user of the system 2 activates the “Command Log” icon, in the preferred embodiment, four text options appear in Quadrant C labeled “Situation”, “After Incident,” “Training” and “Safety” representing different types of activities by the responders. Upon choosing one of these options, a form is generated and appears in Quadrant C for completion by the commander via the computer-user interface 22. The form may be subsequently up-loaded to another computer for electronic submission or printing. Alternately, the commander may type in observational information without the formality of filling out a form.

The “Clock” icon in Quadrant E refers to the activation of a clock program 90 at the commencement of the route or activated through electronic/automated means. The clock 90, in association with the GPS receiver 40, may be further activated at set intervals (e.g., every 5, 8, and 15 minutes) to record the location of the emergency response vehicle along the route to the incident site at specific time intervals.

The “Personnel” icon, once activated, causes the display of information in Quadrant C related to personnel within the fire district's organization for handling a particular emergency based on the individuals' training and certifications. Similar information regarding other personnel in neighboring jurisdictions is also accessible. The “Equipment” icon, once activated, causes the display of information in Quadrant C regarding the types of equipment available to the commander. The “Radio” icon, once activated, provides the commander with information regarding the radio frequencies available for use for communications regarding the emergency incident. The “Hours” icon provides the commander information regarding the amount of time at a fire or other incident through programmed coordination with the clock program 90 or through links to real-time information. The “Alarm” icon, when activated, allows a commander to enter in a number in Quadrant C representing the level of fire and safety risks involved based on the commander's judgment (e.g., level 2, 3 or 4). In the preferred embodiment, after the commander has selected the alarm level, the computer is programmed to optionally automatically wirelessly emit the Alarm rating to the dispatcher/central command relieving the commander of the responsibility for calling with that information. The “Rating” icon allows the commander to rate the incident by type in Quadrant C, e.g., as a wild fire, urban fire, life threatening emergency, automobile accident, chemical spill, chemical hazards emergency and other incident categories. In the preferred embodiment, the computer is also programmed to automatically wirelessly emit the rating to the dispatcher/central command relieving the commander of the responsibility for calling with that information.

An alternate embodiment includes a “Command Override” icon or function in Quadrant E allowing a commander to either automatically, or upon entry of an access code, take control over the single or multiple laptop computers 26 in the responder vehicle(s). The system comprises means for wirelessly coupling the computer 26 to at least one other computer for the exchange of data. The commander then oversees the response and maintains control over the information given to the responders so that the commander and various crews are able to view identical information while traveling to the incident site in separate vehicles. The Command Override function may be activated either in one vehicle or remotely in the event the commander is overseeing the response from a remote location.

A second alternate embodiment includes an obstacle warning system, whereby the responders are alerted to potential hazards in the route as they approach the incident site. At a set point of distance ahead of the hazard, the application 44 automatically, and without displacing existing displayed data, overrides the screen display 24 with a wizard overlay and warning box displaying information regarding the distance to the potential hazard and the nature of the potential hazard. For example, if the field survey route data 10 revealed a culvert in a private road which may not maintain the weight of an emergency vehicle, the location of that culvert is documented as part of the field survey by GPS coordinates along with coordinates at a set distance in advance of reaching the culvert. Upon reaching that advance point based on the GPS location of the emergency vehicle as compared to the GPS coordinates previously recorded, the application 44 automatically displays the warning box regarding the culvert and provides the responders with advance notice of the potential hazard via textual and/or photographic images.

FIG. 6 is an alternate exemplary user interface screen display 24/critical data display 24 with multiple windows. A gloved hand 88 of a responder is shown touching the photograph containing a view of the vegetation 64 in Quadrant D with the corresponding larger photograph of the vegetation 64 displayed in Quadrant C. If a user touches another icon in Quadrant B, the photograph in Quadrant C is removed with the selected information appearing instead in Quadrant C. The selected icons are highlighted or bolded at their edges to signify their selection.

The screen display 24 is programmed to be responsive to touch by a bare hand or a gloved hand 88, and alternately, to at least one of a bare hand, a gloved hand, a voice command, a stylus, a computer mouse, and/or an optical screen pointer. As the responder reaches reference points along the route, the responder has the option of changing the view of the map image in Quadrant A to focus on the remaining portion of the route. Alternatively, as the vehicle moves, and the location of the vehicle is tracked by the GPS receiver, the program may include reference points which automatically update the map display in Quadrant A. In addition, other response vehicles, also containing GPS receivers, may be visible on a map image in Quadrant A on the screen display 24 with their location automatically updated as the vehicles approach the incident site.

The display screen 24 may be customized to display preferred information (additional or less information) in a preferred format to meet the needs or preferences of the responders and/or the incident commander.

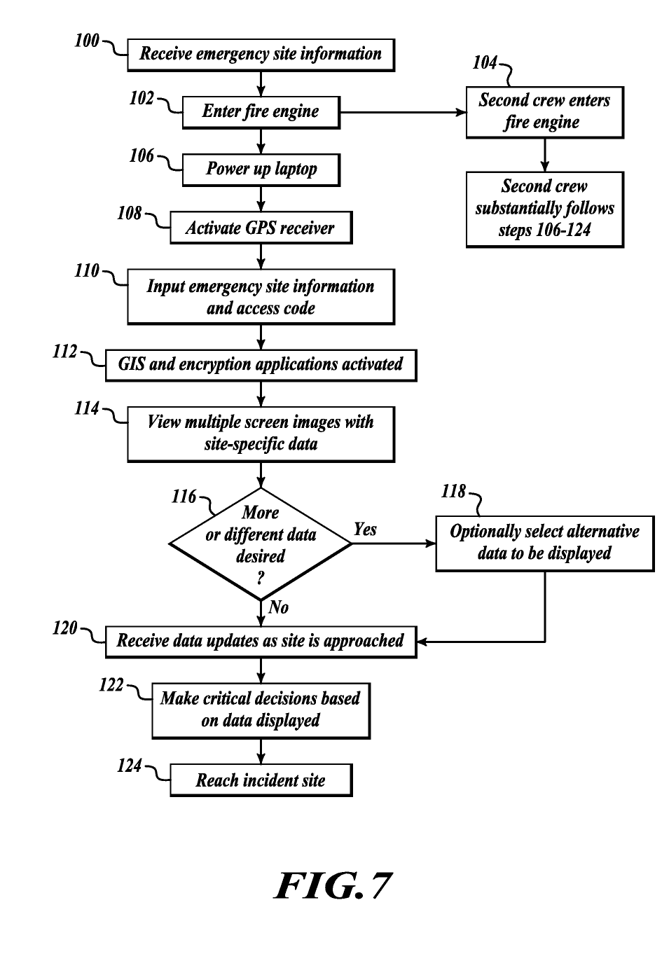

FIG. 7 is a flow chart of a method for responders utilizing the present invention upon receipt of notice of an emergency event. In step 100, a responder receives notice of an emergency event, typically from a dispatcher, and associated limited information, such as a site address, regarding location of the incident. For purposes of FIG. 7, the responder is assumed to be a fire fighter at a fire station or an emergency medical technician, and the event is assumed to be a fire, accident or other incident at a home site located in a rural region.

In step 102, a first crew of fire fighters, EMTs or other responders (“First Crew”) enters the fire engine, ambulance or other first responder/emergency vehicle(s) at the station with handwritten or printed emergency site information. In step 104, a second crew of one or more additional fire fighters, EMTs or other responders enters an emergency vehicle either at the same location or at a different station (“Second Crew”). The Second Crew substantially follows the remaining steps of FIG. 7.

In step 106, the First Crew starts the vehicle and powers up the laptop computer either by activating the computer from standby/sleep mode or by turning the power to the computer on. The laptop computer is located in a docking station mounted to the vehicle's dashboard. In step 108, the First Crew activates a GPS receiver mounted within the fire engine, said GPS receiver being linked by USB port or wireless connection to the laptop computer. In step 110, the First Crew manually or by voice command inputs the incident data/standard emergency site information and access code into the laptop computer as the vehicle departs the station. Alternatively, the dispatch station wirelessly pushes the emergency site information and/or access code to the laptop computer for automatic download.

In step 112, the GIS-based extension application 44 on the laptop computer is activated and compares the standard emergency site information to coded field data 10, 11 and other data previously downloaded to the laptop computer. In response, in step 114, the laptop computer automatically displays at least one screen image comprising relevant map-based information, photographs, detailed thumbnail narratives and/or real-time information received through the GPS receiver or other remote sensors.

In step 116, the First Crew determines whether it wants different or additional information. If yes, the First Crew may select alternate data to be displayed in Step 11 8, including without limitation, new or updated route information and road conditions; fire address and/or Geocode attributes including vegetation and topographical information; best vehicle deployment locations, and site and access photograph images.

In step 120, the laptop computer may be programmed to automatically update information, such as map screens, at certain intervals along the route to the site. Alternatively, the First Crew may select updated information to be displayed through manual input and/or voice command at desired intervals along the route.

In step 122, the First Crew incident commander and/or other members of the First Crew view the critical data displayed on the user interface and make critical decisions relating to crew safety, victim safety, accessing the site, equipment deployment, required/desired hose connections, hose size(s), hose length(s), and other critical incident management decisions in advance of reaching the incident site. Step 122 may occur earlier in the route and at different intervals along the route.

In step 124, the First and Second Crews safely reach the incident site with a faster response time. The Crews deploy equipment to address the emergency. The Crews maintain communications with the station for reports and updates.

### INDUSTRIAL APPLICABILITY

It is clear that the inventive Responder Route and Site-Specific Critical Data System has wide applicability to the emergency response industry, namely to providing emergency responders with critical information needed to achieve faster response times, increase crew and equipment safety, minimize structural damage, increase opportunity to save lives, provide a means for incident management while traveling to the incident site, reduce time and expense of organizational processing, and provide more time for responder training, rather than data collection and recording. The invention has a wide application to other industries and customers, including state and local agencies, delivery services, and private and commercial property owners. Secure access to the route and site data may be given on a multi-district, single district, or single route basis via a subscription-type mode of access.

It should be understood that various modifications within the scope of this invention can be made by one of ordinary skill in the art without departing from the spirit thereof and without undue experimentation. For example, the screen displays may be customized to meet the needs of various emergency responders or other industries, such as private or public mail delivery, the insurance industry (to provide better estimates of risks and exposures), and transportation of goods or hazardous materials. The field survey data may be collected by field technicians on the ground, or by any other suitable means such as overhead images of the potential incident site. The user interface could employ any suitable means for displaying the information to the responders, including laptop screens, PDAs, or projected images upon surfaces or the windshield of the emergency response vehicle. This invention is therefore to be defined as broadly as the prior art will permit, and in view of the specification if need be, including a full range of current and future equivalents thereof.

### PARTS LIST to assist examination; may be cancelled upon allowance at option of the Examiner

| | |
|---|---|
| 2 | Responder Route and Site-Specific Critical Data System |
| 4 | Field Data Collection System |
| 6 | Database Maintenance System |
| 8 | User Interface System |
| 10 | field survey route data |
| 11 | field survey site data |
| 12 | field technician |
| 14 | device for collecting field survey data |
| 16 | database |
| 18 | remote database |
| 20 | computer |
| 22 | computer-user interface or keyboard |
| 24 | computer screen display or critical data display |
| 26 | laptop computer |
| 28 | data upload/encryption |
| 31 | vehicle |
| 32 | data downloads and updates |
| 36 | public domain data |
| 38 | map and image data and database |
| 40 | receiver |
| 41 | GPS data |
| 44 | critical data display application program |
| 45 | GPS System |
| 46 | updated field survey site data |
| 48 | updated field survey route data |
| 50 | updated client data |
| 52 | updated agency data |
| 54 | updated map images |
| 55 | data pertinent to one district |
| 56 | station |
| 57 | highway |
| 58 | potential or actual incident site |
| 59 | outbuildings |
| 60 | route |
| 61 | deployment area |
| 62 | public/private intersection |
| 63 | staging area |
| 64 | vegetation |
| 66 | private road |
| 68 | utilities |
| 70 | water |
| 71 | gate |
| 72 | hazardous conditions |
| 73 | driveway |
| 74 | aerial view of site |
| 88 | gloved hand of responder |
| 90 | clock |

We claim:

1. A computer-enabled critical decision assist system for collecting, maintaining, and providing information to at least one emergency responder relating to an emergency travel route and an emergency incident site comprising in operative combination:
a field data collection system for collecting field survey route data and field survey site data;
at least one database that includes the field survey route data and field survey site data;
a user interface system comprising:
at least one computer;
at least one computer-user interface;
at least one computer screen display;
at least one district database accessible by said computer; and
a critical data display application program capable of automatically generating and displaying at least one critical data display;
whereby information is provided to the responder to assist the responder in making at least one critical decision in advance of reaching the incident site.

2. The system of claim 1, further comprising at least one wireless receiver interfaced with said system.

3. The system of claim 2, where the receiver is a global positioning satellite receiver.

4. The system of claim 1, further comprising at least one receiver and at least one browser programmed to receive and communicate updated real-time information to the system.

5. The system of claim 1, further comprising a clock capable of calculating and recording the passage of time along the emergency travel route.

6. The system of claim 1, further comprising a global positioning satellite receiver interfaced with a second software application capable of calculating and recording the passage of time and location of an emergency vehicle at specified time intervals.

7. The system of claim 1, further comprising means for wirelessly coupling the computer to at least one other computer for the exchange of data.

8. The system of claim 1, where at least one of the field survey route data and field survey site data are recorded by at least one field technician through the use of at least one of: manual recordings, a cell phone, a PDA, a tablet computer, a global positioning system receiver, a clock, a camera, a video recorder, a voice recorder and a laptop computer.

9. The system of claim 1, where the field survey route data includes data relating to a portion of the emergency travel route located past the public-private intersection.

10. The system of claim 1, where the field survey site data includes data relating to the emergency incident site located past the public-private intersection.

11. The system of claim 1, where the database includes displayable images and text selected from at least one of: field survey route data, field survey site data, private and public map images, public domain data, site owner contact information, physical addresses, fire addresses.

12. The system of claim 1, where the database includes maps, graphics, photographic images, videos, animations, audio information, narrative information, and combinations thereof.

13. The system of claim 1, where the database is periodically updated to record changed physical conditions.

14. The system of claim 1, where the computer is selected from at least one of: a PDA, a tablet computer, a laptop computer, notebook computer, a cell phone, a smart phone.

15. The system of claim 1, where the computer-user interface permits the input of incident data.

16. The system of claim 1, where the screen display is responsive to at least one of: a touch-screen command by a bare hand, a touch-screen command by a gloved hand, a voice command, a stylus, a computer mouse, an optical screen pointer.

17. The system of claim 1, where the user database includes displayable images and text limited in scope to at least one particular fire district or other agency district.

18. The system of claim 1, where the critical data display application includes a computer-executable GIS extension application.

19. The system of claim 1, where the critical data display application is further programmed to calculate and record the passage of time and location of the vehicle at specified time intervals.

20. The system of claim 1, where the incident data is selected from at least one of: GPS coordinates, Geocode references from a national database, a unique fire address assigned by the fire district, a physical mailing address as used by the post office.

21. The system of claim 1, where the incident data is automatically transmitted to the system and received by wireless means.

22. The system of claim 1, where the critical data display includes at least one of a map, a photographic image, a text narrative, a display of real-time data.

23. The system of claim 1, where the screen display is customized by a user to display preferred information in a preferred format.

24. A method of collecting, maintaining, and providing information critical to at least one emergency responder relating to an emergency travel route and an emergency incident site comprising the steps of:
providing a field data collection system for collecting field survey route data and field survey site data;
maintaining at least one database that includes the field survey route data and field survey site data;
providing a user interface system comprising:
at least one computer;
at least one computer-user interface;
at least one computer screen display;
at least one district database accessible by said computer; and
a critical data display application program capable of automatically generating and displaying at least one critical data display;
viewing of the critical data display by the responder, thereby providing information to make at least one critical decision in advance of reaching the incident site.

25. The method of claim 24, further comprising the steps by at least one responder of:
entering an emergency vehicle;
powering up the computer;
inputting incident data and an access code via the computer-user interface; and
activating the critical decision display application program.

26. A critical data display application program resident in at least one computer for generating and displaying at least one critical data display comprising the functionality of:
entry of incident data;
user access code verification;
access to route and site-specific data corresponding to the incident data;
access to data supplied by at least one receiver; and
automatic generation and display of at least one critical data display.
